(19) United States
(12) Patent Application Publication
(10) Pub. No.: US 2026/0088298 A1
(43) Pub. Date: Mar. 26, 2026

(54) 3DP-NANO-MICRO BATTERY COMPOSITE ELECTRODE MATERIAL AND PREPARATION METHOD THEREOF

(71) Applicant: Shenzhen University, Shenzhen (CN)

(72) Inventors: Saima Batool, Shenzhen (CN); Junguo XU, Shenzhen (CN); Muhammad Idrees, Shenzhen (CN); Xingyu CHEN, Shenzhen (CN)

(73) Assignee: Shenzhen University, Shenzhen, GD (CN)

(21) Appl. No.: 19/403,916

(22) Filed: Nov. 30, 2025

(30) Foreign Application Priority Data
Jul. 21, 2025 (CN) 202510999686.8

(51) Int. Cl. H01M 4/62; B22F 10/64; B28B 1/00; B33Y 10/00; B33Y 40/20; B33Y 70/10; B33Y 80/00; H01M 4/48; H01M 10/052; H01M 50/11; H01M 50/247

(52) U.S. Cl. CPC H01M 4/624; B22F 10/64; B33Y 10/00; B33Y 40/20; B33Y 70/10; B33Y 80/00; H01M 4/48; H01M 10/052; H01M 50/11; H01M 50/247; B22F 2301/255; B22F 2998/10; B28B 1/001; H01M 2220/30

(57) ABSTRACT

The present invention pertains to the field of battery technology and provides a 3DP-nano-micro composite electrode material for high-performance lithium-ion storage, along with its preparation method. In this disclosure, a the V₂O₅—Ti₂C₃—Au nanocomposite cathode material featuring a hierarchical heterostructure for high-performance lithium ion energy storage is disclosed, comprising a 3D-printed V₂O₅—Ti₂C₃—Au cathode, in which an in-situ TiO₂ interface forms via synergistic interactions between V₂O₅, Ti₂C₃Tₓ, and Au nanoparticles. The TiO₂ interface introduces abundant oxygen vacancies that act as Li⁺ adsorption sites. Au nanoparticles contribute to interfacial redox dynamics, catalysis, and conductivity, forming Au—Ti intermetallics that act as conductive bridges, reduce interfacial resistance, and reinforce mechanical stability. The 3D-printed nanocomposite cathode is manufactured by DIW printing technology, which can accurately control the structure and spatial distribution of the active material, thereby shortening the ion/electron pathway and improving the electrochemical kinetics.

### TECHNICAL FIELD

The present disclosure relates to the field of battery technology, particularly a three-dimensional printed (3DP)-nano-micro battery composite electrode material and a preparation method thereof.

### BACKGROUND

The global energy transition and proliferation of portable electronics necessitate advanced energy storage systems. Vanadium pentoxide (V₂O₅) is a prominent cathode material for lithium-ion and sodium-ion batteries, recognized for its high theoretical capacity, multi-electron transfer capability, and strong electrochemical activity. Nevertheless, its commercial deployment is hindered by intrinsic limitations: low electronic conductivity, structural degradation from phase transitions during cycling, and slow ion diffusion kinetics. These issues collectively manifest as rapid capacity fading, limited cycle life, and poor rate capability.

The conventional strategy for mitigating the low conductivity of V₂O₅ involves the incorporation of carbon-based conductive additives, such as graphene and carbon nanotubes. This established methodology, while capable of forming a conductive network, is nevertheless hampered by two principal shortcomings that limit its practical efficacy. A primary shortcoming is the inherent complexity of the synthesis process, which routinely demands high-temperature carbonization and chemical vapor deposition techniques; these requirements contribute to prohibitive manufacturing costs and present significant challenges for achieving a uniform dispersion and precise morphological control of the constituent nanostructures. A further critical shortcoming is the inadequate synergistic interaction between the carbon matrix and the V₂O₅ active material, wherein the carbon component merely forms a physical coating on the V₂O₅ particles. This superficial contact mechanism proves insufficient to effectively restrain the intrinsic structural phase transitions of V₂O₅ during its recurrent lithiation/delithiation cycles, and consequently provides only a marginal enhancement to the fundamental ion transport efficiency.

MXenes have been investigated as a recombination material for V₂O₅ owing to their high electrical conductivity, hydrophilicity, and interlayer ion channel properties. However, in current research, MXenes are predominantly utilized merely as a singular conductive filler. This approach fails to fully exploit the potential for chemical coupling between the surface functional groups of MXene and V₂O₅. Consequently, the composite material exhibits insufficient interfacial stability, and the tendency for MXene lamellae to restack readily obstructs ion transport pathways. As a result, the overall enhancement in structural stability delivered by this strategy remains limited in its effectiveness.

While Au nanoparticles (Au NPs) are known to accelerate electrode reaction kinetics through their surface plasmon effect and intrinsic catalytic activity, significant challenges persist in their integration into V₂O₅-based cathodes. Conventional preparation techniques, such as simple liquid-phase blending, struggle to achieve a uniform dispersion of Au NPs within a complex V₂O₅-MXene matrix and offer no precise control over the electrode's final microstructure. Furthermore, the fundamental synergistic mechanism by which Au NPs and MXenes cooperatively enhance overall conductivity, ion diffusion, and structural stability through interfacial interactions within the V₂O₅ host remains largely unelucidated. Consequently, research in this specific area remains at a nascent stage.

Moreover, conventional electrode preparation relies on casting, pressing and other methods, making it difficult to construct a 3D structure with controllable porosity and conductive network, which collectively result in a low utilization rate of active materials, unsatisfactory rate performance, overcomplicated manufacturing processes, and high production costs, thereby rendering the existing approaches unsuitable for large-scale industrial production.

Therefore, it is a current challenge to develop a 3DP-nano-micro battery composite electrode material and preparation method thereof that can improve conductivity, structural integrity and electrochemical performance.

### SUMMARY

An objective of the present disclosure is to provide a 3DP-nano-micro battery composite electrode material and a preparation method thereof to solve the problems of low conductivity of the current electrode material, unstable structure during cycling, and slow ion diffusion rate.

To achieve the foregoing objective, the present disclosure provides a 3DP-nano-micro battery composite electrode material. The composite electrode material comprises V₂O₅, Ti₂C₃ MXene, and Au nanoparticles.

The V₂O₅ serves as a matrix material, functioning as the primary active substance that provides the fundamental lithium-ion storage sites.

The Ti₂C₃ MXene acts as a conductivity enhancer and structural support, is uniformly dispersed in the V₂O₅ matrix material in a two-dimensional (2D) lamellar structure, and V₂O₅ and Ti₃C₂ MXene are connected by a defect-rich TiO₂ interlayer, in which the TiO₂ interlayer is used to anchor oxides, reduce lattice mismatch and introduce oxygen vacancies.

Au NPs, serving as catalytically active sites and ion transport accelerators, are anchored on Ti sites on the surface of Ti₃C₂ MXene to form conductive interfacial bonds (AuTi₃, Au₂Ti), and are uniformly loaded on the surface of V₂O₅ and MXene lamellar gaps.

The composite material is 3D printed via direct ink writing (DIW) technology to form a grid structure that constructs an interconnected electronic conductive network and a lithium-ion transmission channel, with an accurately control on a structure and a spatial distribution of the active material, thereby shortening an ion/electron transmission pathway.

In some embodiments,, the composite electrode material comprises a lamellar architecture with a monolayer thickness ranging from 10 to 20 micrometers and a total stack configuration of 2 to 8 layers. The individual lamellae interface with the MXene components through a bridging TiO₂ interlayer, establishing heterojunction interfaces that collectively generate a hierarchical heterostructure throughout the electrode material.

In some embodiments, in the above 3DP-nano-micro battery composite electrode material, a pore structure of the composite electrode material is adjusted by adjusting a solid phase content of the printed ink and printing parameters.

A method for preparing a 3DP-nano-micro battery composite electrode material includes the following steps:
S1, preparation of precursor ink, mixing V₂O₅ nanoparticles, Ti₃C₂ MXene material and Au NPs according to a mass ratio of 5:1-3:0.1-1, adding a binder (polyvinylidene fluoride or sodium carboxymethyl cellulose) containing a TiO₂ precursor (such as tetrabutyl titanate) and a solvent (N-methylpyrrolidone or deionized water), ultrasonically dispersing for 1-3 h to form uniform ink, in which the TiO₂ precursor is converted into a defect-rich TiO₂ interlayer in a subsequent treatment.
S2, Utilizing Direct Ink Writing (DIW) technology, the precursor ink is deposited layer-by-layer onto an aluminum substrate through a precision nozzle. The process parameters are controlled to achieve a single-layer printing thickness of 10-20 μm, with an interlayer drying interval of 5-15 minutes. This sequence is repeated for a cumulative total of 2 to 8 layers to form a wet electrode blank.
S3, The wet electrode blank undergoes a two-stage post-treatment process. First, it is vacuum-dried at 60-80° C. for 12-24 hours. Subsequently, a critical heat treatment is performed at 300-400° C. for 1-2 hours under an argon atmosphere. This thermal step serves to remove the organic binder and strengthen interfacial bonds within the composite. Crucially, during this stage, the TiO₂ precursor is thermally converted into a oxygen-deficient TiO₂ interlayer, while simultaneous formation of conductive interface bonds occurs between the Au nanoparticles and the Ti sites on the MXene surface, ultimately yielding the final 3D-printed composite electrode material.

A 3D-printed nano-micro battery structure comprises the following components:

The anode comprises a lithium cobalt oxide material prepared via 3D printing and arranged on a substrate, wherein a positive electrode shell is subsequently affixed a top the substrate assembly.

The cathode is composed of the 3D-printed composite material, arranged on the substrate, and a negative electrode shell is disposed at the bottom of said substrate.

The separator is a porous polyolefin membrane or a ceramic-coated separator, and is arranged between the anode and the cathode, and
an electrolyte is provided, which is an organic electrolyte containing lithium ions. During the charging process, the lithium ions are transferred from the anode to the cathode and inserted into the interlayer structure of the cathode material. During the discharging process, the lithium ions are extracted from the cathode and migrate back to the anode.

In some embodiments, the nano-micro battery is applied to a wearable device, a medical implantable device, or an Internet of Things sensor.

Therefore, the 3DP-nano-micro battery composite electrode material and preparation method thereof have the following beneficial effects:

(1) As a conductive filler within the V₂O₅ matrix, MXene exhibits high electrical conductivity, effectively reducing internal resistance and enhancing the overall electrochemical efficiency. The unique lamellar structure and large specific surface area of MXene provide optimal pathways for lithium-ion transport, thereby accelerating the insertion and extraction processes. In addition, MXene enhances the mechanical stability of V₂O₅, mitigating structural degradation during repeated cycling and improving long-term cycling performance. The incorporation of Au nanoparticles (Au NPs) further increases the electronic conductivity of the composite, facilitating efficient electron transfer during battery operation. The presence of Au NPs accelerates charge transfer at the electrode-electrolyte interface, thereby improving the kinetics of lithium intercalation and deintercalation and resulting in a faster electrochemical response. Moreover, Au NPs act as additional nucleation sites, promoting uniform and efficient lithium-ion intercalation and further enhancing the overall cycling stability of the battery.

As well, Au NPs catalyzed the reaction of MXenes with V₂O₅ to promote the generation of TiO₂ in the interfacial layer. The combination of V₂O₅, MXenes, and Au NPs yielded a synergistic effect where each component enhanced the overall performance. V₂O₅ served as the active substance, while MXenes and Au NPs simultaneously improve the electronic and ionic conductivity. With the improvement of electron and lithium-ion transport pathways, the kinetics of insertion and extraction processes are significantly enhanced, thus enabling faster charging and discharging rates. The structural enhancement of MXenes, combined with the conductive advantages of Au NPs, leads to improved cycling stability, which significantly reduces capacity decay in long-term use. The designed and constructed V₂O₅—Ti₂C₃ heterostructures are interconnected by interfacial TiO₂ layers, which promote the formation of oxygen vacancies and the generation of local stresses, and the intercalation of lithium ions is enhanced through synergistic redox and electronic interactions. The titanium atoms are further anchored with Au NPs to form gold-titanium bonds (AuTi₃, Au₂Ti), further improving the interfacial conductivity and structural integrity. The interfacial TiO₂ layer formed between V₂O₅ and Ti₂C₃ can anchor the oxide, reduce lattice mismatch, introduce oxygen vacancies, and promote electron/ion transport, thereby improving the electrochemical performance. The 3DP-VTA composite material provides ideas for higher-performance energy storage systems.

(2) The lamellar architecture constructed by the 3DP-DIW technology forms an interconnected ion transport channel and an electronic conductive network to enhance ion transport and overall energy density. The precise control of the electrode thickness, porosity, and geometry is achieved through additive manufacturing technology, which satisfies the customized requirements for battery volume and performance of different microdevices and supports rapid iterative optimization; as well as optimized material usage to reduce waste.

(3) The 2D conductive layer of MXenes and the catalytic sites of Au NPs are synergistically integrated into the V₂O₅ matrix to form a “conductive-catalytic-structural support” multifunctional composite system, which solves the problem that a single carbon-based material (such as graphene) only physically enhances conductivity and cannot suppress structural phase transition. Direct ink writing 3D printing technology enables the precise integration of nanoscale material dispersion with macroscopic structural control. Compared with conventional coating methods, this approach effectively prevents the agglomeration of active materials and ensures a uniform distribution of conductive additives. Moreover, it eliminates the need for high-temperature sintering, thereby reducing energy consumption and enhancing suitability for large-scale production.

(4) The electrode thickness can be precisely controlled, and when integrated with a 3D-printed multilayer stacked battery architecture, it meets the requirements of wearable devices—such as smart watches and implantable sensors—for compact size and long battery life. The excellent structural stability of the design ensures consistent electrochemical performance under complex operating conditions, including bending and vibration. This makes the battery particularly suitable for outdoor applications in Internet of Things (IoT) terminal devices, such as wireless sensor nodes.

Further detailed descriptions of the technical solution of the present disclosure can be found in the accompanying drawings and embodiments.

### BRIEF DESCRIPTION OF THE DRAWINGS

FIG. 1 is a scanning electron microscope (SEM) image of V₂O₅;

FIG. 2 is an SEM image of MXene;

FIG. 3 is an SEM image of Au NPs;

FIG. 4 is an SEM image of Au NPs and MXene integrated V₂O₅;

FIG. 5 is an SEM image of a 3D-printed sample;

FIG. 6 is a close-up SEM image of a 3D-printed sample;

FIG. 7 is an optical image of a 3D-printed sample on an aluminum substrate;

FIG. 8 is a schematic diagram of a nano-micro battery;

FIG. 9 is a cyclic voltammetry test diagram of a nano-micro battery;

FIG. 10 is a test diagram of a nano-micro battery at different current densities;

FIG. 11 is a test diagram of a long-term electrochemical cycle of a nano-micro battery.

### REFERENCE NUMERALS IN FIGURES

1, an anode; 2, a substrate; 3, a positive electrode shell; 4, a cathode; 5, a negative electrode shell; 6, a separator; 7, an electrolyte.

### DETAILED DESCRIPTION OF THE EMBODIMENTS

The following is a detailed description of the above technical solution, which will be explained in conjunction with the accompanying drawings and specific embodiments to facilitate a better understanding. Apparently, the described embodiments are only some, but not all of the embodiments of the present disclosure. All other embodiments obtained by those of ordinary skill in the art based on the embodiments of the present disclosure without involving any creative effort shall fall within the scope of protection of the present disclosure.

The terms used in the embodiments of the present disclosure are intended solely for the purpose of describing specific embodiments and are not intended to limit the scope of the present disclosure. The singular forms “a,” “the,” and “said” used in the embodiments of the present disclosure and the appended claims are also intended to include plural forms, unless the context clearly indicates otherwise, and “pluralit” generally includes at the very least two.

It should also be noted that the terms “including,” “comprising,” or any other variant thereof are intended to cover non-exclusive inclusion. Thus, a product or apparatus comprising a series of elements not only includes those elements but also includes other elements not specifically identified, or elements inherent to such a product or apparatus. Where no further limitation is provided, an element defined by the phrase “including one . . . ” does not exclude the presence of additional identical elements in the goods or apparatus that include the element.

The present disclosure provides a 3DP-nano-micro battery composite electrode material comprising V₂O₅, Ti₂C₃ MXene, and Au nanoparticles (Au NPs). In the composite, V₂O₅ serves as the matrix material and acts as the active component, providing lithium-ion storage sites. Ti₂C₃ MXene functions as a conductivity enhancer and structural support, uniformly dispersed within the V₂O₅ matrix in a two-dimensional lamellar configuration. The two components are interconnected through a defect-rich TiO₂ interlayer, which anchors oxides, reduces lattice mismatch, and introduces oxygen vacancies. Au NPs serve as catalytic active sites and ion transport accelerators. They are anchored at Ti sites on the surface of Ti₂C₃ MXene, forming conductive interfacial bonds (AuTi₃, Au₂Ti), and are uniformly distributed on the surfaces of V₂O₅ and within the interlayer gaps of the MXene. The composite electrode material is fabricated via direct ink writing (DIW) technology, producing a lamellar stacked architecture that establishes an interconnected electronic conductive network and efficient lithium-ion transport channels. The structural design allows precise control over the morphology and spatial distribution of active materials, thereby shortening the ion and electron transport pathways.

The 3D-Printed stacked structure has a monolayer thickness ranging from 10 to 20 micrometers, and a total stack configuration of 2 to 8 layers, and the interlayers form a heterojunction interface with the MXene layer via the TiO₂ interlayer, so that the composite electrode material exhibits the hierarchical heterostructure. The pore structure of the composite electrode material is adjusted by adjusting the solid phase content of the printed ink and printing parameters. The V₂O₅ serves as the matrix material and active substance, features a high theoretical capacity and provides a large number of lithium-ion storage sites, which is the key material for achieving battery energy storage. MXene exhibits a 2D lamellar structure and is uniformly dispersed within the V₂O₅ matrix. As a conductivity enhancer, its high electrical conductivity significantly reduces electrode resistance and improves electron transport efficiency. Furthermore, as a structure support, it enhances the mechanical stability of the electrode, mitigating the decay in performance caused by structural changes during charging and discharging. Au NPs uniformly loaded on the V₂O₅ surface and within MXene lamellar gaps, serving as catalytically active sites, accelerate charge transfer reactions at the electrode interface and optimize the kinetics of lithium intercalation and delithiation. Furthermore, as ion transport accelerators, they provide additional ion transport pathways, which promote rapid lithium-ion migration.

This 3DP structure constructs an interconnected electron conductive network, which enables electrons to be rapidly transmitted inside the electrode. Meanwhile, the interlayer voids form a lithium-ion transmission channel, which provides a convenient pathway for the insertion and extraction of lithium ions during the charging and discharging process, thereby improving the charging and discharging efficiency and overall performance of the battery.

The MXene material possesses a unique two-dimensional structure and abundant surface functional groups, enabling the formation of stable interfacial bonds with the V₂O₅ matrix through both chemical bonding and physical interactions. This strong interfacial coupling effectively enhances the electrical conductivity and structural integrity of the composite electrode. Furthermore, various types of MXene materials exhibit distinct physicochemical and electrochemical properties. By judiciously selecting and combining different MXenes, the overall performance of the composite electrode material can be finely tuned and significantly optimized.

The pore structure of the composite electrode material is regulated by adjusting the solid phase content of the printing ink and printing parameters. A suitable pore structure can increase the specific surface area of the electrode and provide more active sites, which is conducive to the adsorption and intercalation of lithium ions, and the optimized pore distribution can shorten the diffusion pathway of lithium ions and increase the ion diffusion rate, thereby improving the charging and discharging performance and cycle stability of the battery.

A method for preparing a 3DP-nano-micro battery composite electrode material includes the following steps:
S1, preparation of precursor ink, V₂O₅ nanoparticles, Ti₃C₂ MXene material and Au NPs are mixed according to the mass ratio of 5:1-3:0.1-1, the binder (polyvinylidene fluoride or sodium carboxymethyl cellulose) containing the TiO₂ precursor (such as tetrabutyl titanate) and the solvent (N-methylpyrrolidone or deionized water) are added, ultrasonically dispersed for 1-3 h to form uniform ink, in which the TiO₂ precursor is converted into the defect-rich TiO₂ interlayer in a subsequent treatment. The components are thoroughly mixed and homogenized through ultrasonic dispersion, the binder is helpful in maintaining the stability and formability of the ink, and the solvent ensures that all substances are uniformly dispersed throughout the system, so as to provide a good foundation for subsequent printing and molding.
S2, The DIW technology is utilized, the precursor ink is deposited layer-by-layer onto the aluminum substrate through the precision nozzle. The process parameters are controlled to achieve a single-layer printing thickness of 10-20 μm, with the interlayer drying interval of 5-15 min. This sequence is repeated for a cumulative total of 2 to 8 layers to form a wet electrode blank. DIW technology provides precise control on the shape and structure of electrodes, achieving customized designs; layer-by-layer printing and interlayer drying ensure the lamellar structure and interlayer bonding strength of electrodes, providing the foundation for forming interconnected electronic conduction networks and lithium-ion transport pathways.
S3, The wet electrode blank undergoes a two-stage post-treatment process. First, the wet electrode blank is vacuum dried at 60-80° C. for 12-24 h. Subsequently the heat treatment is performed at 300-400° C. for 1-2 h in the argon atmosphere. This thermal step serves to remove the organic binder and strengthen interfacial bonds within the composite. Crucially, during this stage, the TiO₂ precursor is thermally converted into a oxygen-deficient TiO₂ interlayer, while simultaneous formation of conductive interface bonds occurs between the Au nanoparticles and the Ti sites on the MXene surface, ultimately yielding the final 3D-printed composite electrode material. The solvent is removed through vacuum drying, so that the electrode blank undergoes preliminary solidification; the heat treatment in an argon atmosphere can remove the organic binder, avoiding its impact on electrode performance, while simultaneously promoting interfacial bonding between V₂O₅, MXene, and Au NPs, to enhance the stability and conductivity of the composite material.

The 3DP-nano-micro battery structure comprises the following components:

The anode 1 comprises a lithium cobalt oxide material prepared via 3D printing and arranged on the substrate 2, and the positive electrode shell 3 is subsequently affixed the top of the substrate 2. Lithium cobalt oxide exhibits a high voltage plateau and energy density, enabling it to deliver elevated output voltage when used as an anode material. 3D-printed anodes can be customized in shape and structure to meet specific requirements, enhancing space utilization. The positive electrode shell provides structural support and protection for the anode while facilitating electrical connections.

The cathode 4 is composed of the 3D-printed composite material, arranged on the substrate 2, and the negative electrode shell 5 is disposed at the bottom of the substrate 2. The 3D-printed composite electrode material of the present disclosure serves as the cathode, which combines the advantages of V₂O₅, MXene, and Au NPs, exhibiting high conductivity, excellent structural stability, and rapid ion transport capabilities, enabling efficient storage and release of lithium ions during the charging and discharging process. The negative electrode shell provides protection and structural support for the cathode, ensuring the stability and safety of the battery.

The separator 6 is a porous polyolefin membrane or a ceramic-coated separator, and is arranged between the anode 1 and the cathode 4. The primary function of separator 6 is to prevent direct contact between anode 1 and cathode 4, thereby avoiding short circuits, while allowing lithium ions to pass through. The porous polyolefin membrane or the ceramic-coated separator features appropriate porosity and ionic conductivity, which can promote the smooth transmission of lithium ions under the premise of ensuring battery safety.

The electrolyte 7 is provided, which is the organic electrolyte containing lithium ions. During the charging process, the lithium ions are transferred from the anode 1 to the cathode 4 and inserted in the interlayer structure of the cathode material. During the discharging process, the lithium ions are extracted from the cathode and migrate back to the anode. The electrolyte is used as the transmission medium of lithium ions. During the charging process, lithium ions are removed from the anode, migrate to the cathode through the electrolyte and are inserted in the interlayer structure of the cathode material to achieve the storage of electrical energy. During the discharging process, lithium ions are extracted from the cathode and migrate back to the anode through the electrolyte, thus releasing electrical energy to power the devices.

The nano-micro battery is applied to a wearable device, a medical implantable device, or an Internet of Things sensor. Due to their high performance and miniaturization, they can satisfy the requirements of these devices for compact size, high energy density, and excellent cycle stability. They provide sustained power support for wearable devices, ensure reliable operation of medical implantable devices, and deliver a stable energy supply to Internet of Things sensors, thereby promoting development in related fields.

### Embodiment 1

### Preparation of a 3DP-Nano-Micro Battery Composite Electrode Material:

Preparation of precursor ink: 60 g of V₂O₅, 30 g of Ti₃C₂MXene material, and 10 g of Au NPs are mixed, 5 g of polyvinylidene fluoride binder and 100 g of N-methylpyrrolidone solvent are added, and ultrasonically dispersed for 2 h to form the uniform ink.

3D printing molding: the DIW technology is utilized, the precursor ink is deposited layer-by-layer onto an aluminum substrate through a 100 μm nozzle. The process parameters are controlled to achieve a single-layer printing thickness of 15 μm, with the interlayer drying interval of 10 min. This sequence is repeated for a cumulative total of 6 layers to form a wet electrode blank.

Post-treatment: the wet electrode blank is vacuum dried at 70° C. for 18 h, then the heat treatment is performed at 350° C. for 1.5 h under an argon atmosphere, thereby obtaining the 3DP-nano-micro battery composite electrode material.

### Embodiment 2

### Assembly of Nano-Micro Battery:

Preparation of anode, lithium cobalt oxide powder is mixed with binder and conductive agent in a certain proportion to make a slurry, the slurry is printed on the substrate by 3D printing to form the anode, and the positive electrode shell is subsequently affixed atop the substrate assembly.

Preparation of cathode, the 3DP-nano-micro battery composite electrode material prepared in embodiment 1 is used as the cathode, and arranged on the substrate, and the negative electrode shell is disposed at the bottom of the substrate.

Separator and electrolyte, the porous polyolefin membrane separator is placed between the anode and the cathode, and an organic electrolyte containing LiPF₆ is injected to assemble a nano-micro battery.

The performance of V₂O₅, MXene and Au NPs used in embodiments 1-2, the prepared composite electrode materials, and the prepared nano-micro battery are tested.

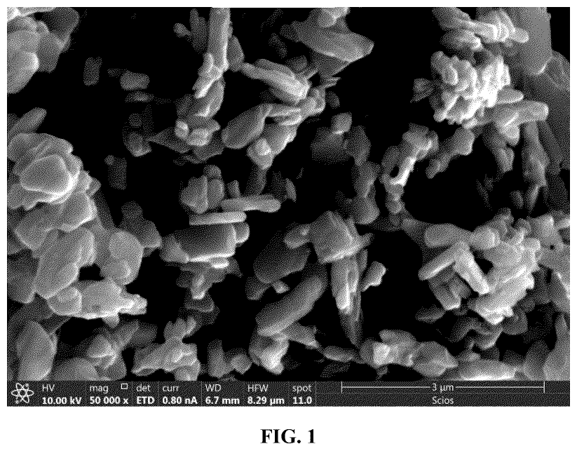

As shown in FIG. 1, the SEM image of the 2D lamellar V₂O₅ material is presented, depicting its structural characteristics and particularly highlighting the 2D lamellar morphology. This specific structure is crucial for improving the electrochemical performance, as the lamellar configuration is conducive to efficient lithium-ion insertion, which in turn contributes to the material's high capacity and cycle stability.

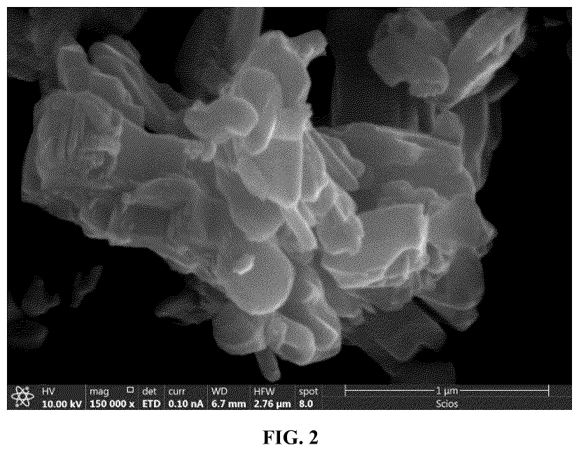

As shown in FIG. 2, an SEM image of a 2D lamellar MXene material, specifically MXene (Ti2C3Tix), is presented. MXenes represent a class of transition metal carbides, nitrides, or carbonitrides that are renowned for their exceptional conductivity, large specific surface area, and outstanding electrochemical properties. These characteristics collectively render MXenes highly suitable for applications in lithium-ion batteries, particularly in enhancing the performance of both positive and negative electrodes, thereby improving the overall energy storage capacity and cycle life of the battery.

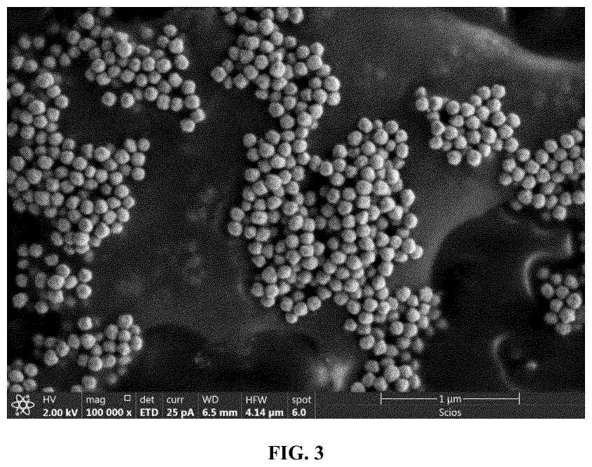

As shown in FIG. 3, an SEM image of Au NPs is presented. Au NPs are integrated into battery materials to enhance the electrochemical properties and overall performance of lithium-ion batteries. They exhibit unique electronic properties and a high surface area, which contribute to improved conductivity, structural stability, and capacity retention within the battery system. These nanoparticles are strategically incorporated into battery electrodes to optimize charge-discharge cycling and enhance the durability of the material.

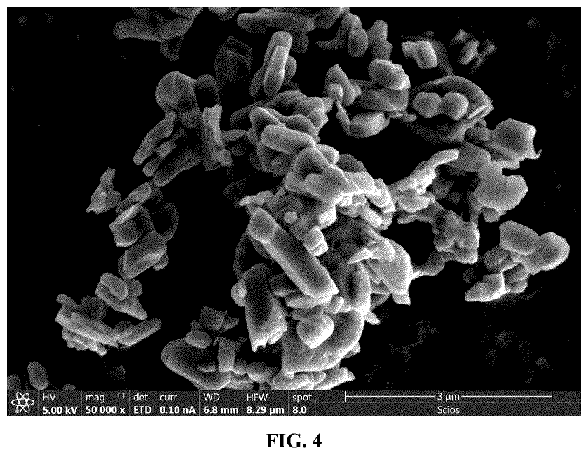

As shown in FIG. 4, an SEM image of a hybrid nanocomposite material integrating V₂O₅, MXene, and Au NPs is presented. This composite material combines the unique properties of each component to enhance the performance of lithium-ion batteries, optimizing electrical conductivity, capacity, and cycling stability to improve energy storage.

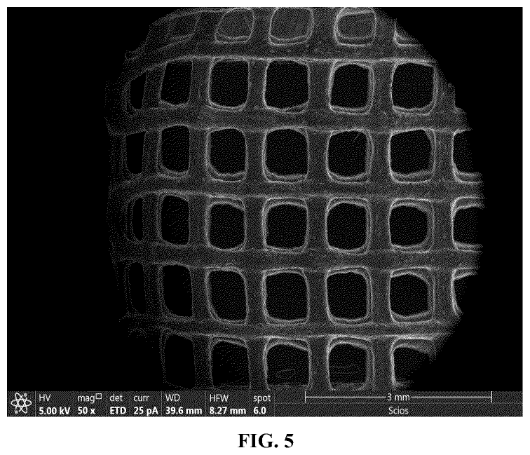

As shown in FIG. 5, an SEM image of the 3D-printed sample is presented, which shows the SEM image of the 3D-printed cathode material prepared by DIW technology, displaying the detailed morphology and structural features of the printed layer.

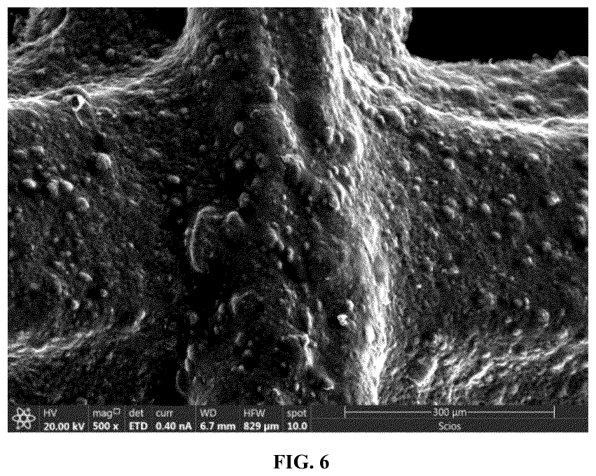

As shown in FIG. 6, a close-up SEM image of the 3D-printed sample is presented. The sample is a complete cathode structure, as shown in the optical image, which consists of six layers mounted on an aluminum substrate. This multi-layer design serves to enhance the performance of lithium-ion batteries.

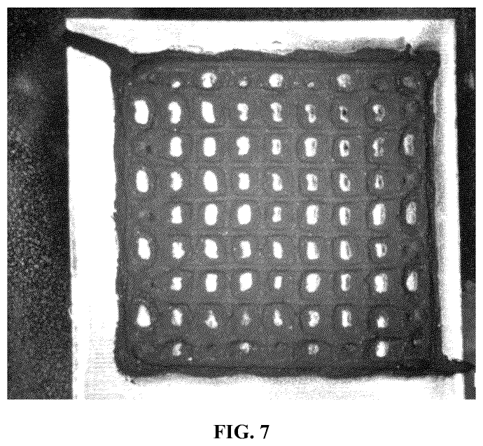

As shown in FIG. 7, an optical image of the 3D-printed sample on an aluminum substrate is presented, which explains the 3D-printed cathode developed using V₂O₅ as the substrate material. MXene and Au NPs at different ratios are integrated to enhance the electrochemical performance of the anode. In the FIG. 7, the white part is the base material aluminum, and the black part is the cathode material; the whole structure is the cathode after processing; the white frame is an aluminum foil used for pasting the cathode material; and the black cathode material and white aluminum foil constitute the cathode part of the battery. The cathode material is a line with a thickness of 10-20 μm. Each layer of the anode is designed with a thickness of approximately 10 μm. Typically, 2-8 layers are applied during construction, which contributes to overall structural integrity and performance. Stereolithography and DIW technology are used to precisely control material deposition and structural configuration. The optimized surface area facilitates greater interaction between lithium ions and the active material, thus significantly improving the overall performance of the anode in energy storage applications.

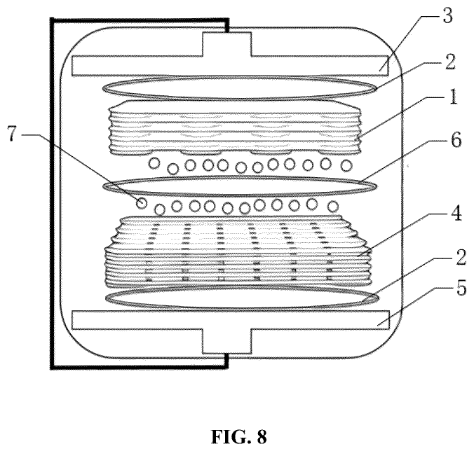

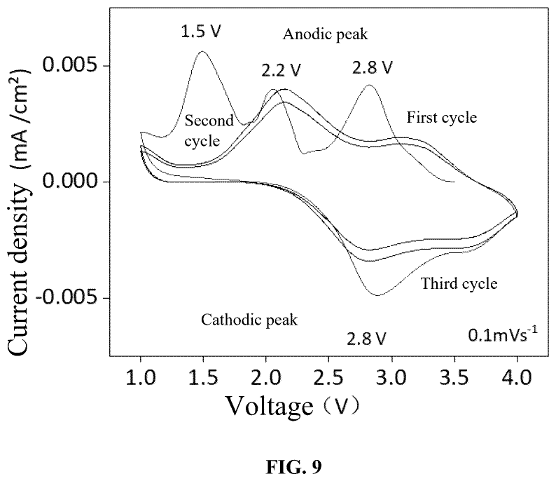

FIG. 8 is a schematic diagram of the nano-micro battery; FIG. 9 is a cyclic voltammetry test diagram of the nano-micro battery, and presents the cyclic voltammetry test results for this battery, which demonstrate anodic and cathodic scans and highlight the characteristic electrochemical behavior of the hybrid material composed of V₂O₅, MXene, and Au NPs. Multiple curves correspond to cyclic voltammetric scans of the V₂O₅—Ti₃C₂—Au cathode across multiple cycles in the lithium-ion battery, particularly in the first, second, and third cycles. These curves provide evidence of the electrochemical reversibility and stability of this composite electrode material during lithium ion insertion/extraction processes. The nearly overlapping redox peaks indicate high reversibility and stable charge-discharge behavior. During the anodic scanning process, lithium ions exit from the electrode and initiate the oxidation reaction, while during the cathodic scanning process, lithium ions re-enter the electrode and undergo a reduction reaction. The obvious characteristic peaks corresponding to V₂O₅, MXene and Au reflect the redox activity of these components in the composites. These peaks indicate the successful integration of each material and each material contributes to the overall electrochemical profile. Multiple sharp redox peaks observed in the range of approximately 1.5 V to 3.0 V, indicating the stepwise insertion/extraction of lithium within the V₂O₅ layers. These redox signatures confirm that the material exhibits pseudocapacitive and Faradaic response characteristics. The introduction of Ti₃C₂ MXene improves electronic conductivity, while Au NPs promote charge transfer kinetics and activate more active sites that can participate in electrochemical reactions. This characteristic behavior highlights the potential of the hybrid material to enhance reversibility, stability and performance in lithium-ion battery applications.

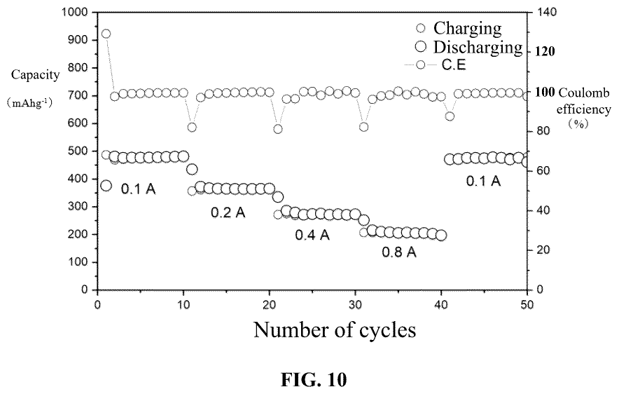

FIG. 10 is a test diagram of the nano-micro battery at different current densities (0.1 A, 0.2 A, 0.4 A, 0.8 A, and return to 0.1 A) to evaluate the performance under different load conditions. The rate performance, stability and adaptability to realistic scenarios of the material are tested at various current densities to ensure that the battery maintains high efficiency and high capacity under different usage conditions.

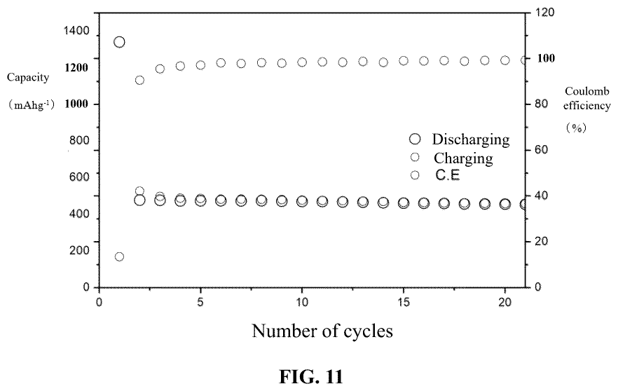

FIG. 11 presents the results of a long-term electrochemical cycle, which involves repeated charging and discharging of the battery over a long period of time. This test evaluates the durability, stability and capacity retention of battery materials under realistic operating conditions, which are important indicators of lithium-ion battery performance. The results show that the battery exhibits a high specific capacity of 455.87 mAh/g at a current density of 0.1 A, which highlights its ability to store a large amount of energy. Additionally, the 99.89 % cycle efficiency (C.E.) highlights excellent stability and minimal capacity decay over long cycles, indicating that the material is a promising candidate for high-performance and long-life lithium-ion batteries. These findings reflect the potential of innovative materials to meet the requirements of commercial applications that require high-capacity and stable energy storage solutions.

Therefore, in the 3DP-nano-micro battery composite electrode material and preparation method thereof according to the present disclosure, as a conductive filler in the V₂O₅ matrix, MXenes have the characteristics of high conductivity. This integration reduces resistance and improves overall efficiency. The unique lamellar structure and large specific surface area of MXenes provide the optimal pathway for lithium ion transport, significantly accelerating the insertion and extraction processes. MXenes contribute to the mechanical stability of V₂O₅, which mitigates the risk of structural collapse during cycling and improves the long-term cycling performance. The introduction of Au NPs improves the electronic conductivity of the composite material, which is beneficial for efficient electron transfer during battery operation. Au NPs can accelerate the charge transfer at the electrode interface, thereby improving the kinetics of lithium intercalation and delithiation, providing a faster cell response time. Furthermore, the presence of Au NPs provides additional nucleation sites, which promote uniform and efficient lithium ion intercalation, and enhance the overall cycle stability.

As well, Au NPs catalyzed the reaction of MXenes with V₂O₅ to promote the generation of TiO₂ in the interfacial layer. The combination of V₂O₅, MXenes, and Au NPs yielded a synergistic effect where each component enhanced the overall performance. V₂O₅ served as the active substance, while MXenes and Au NPs simultaneously improve the electronic and ionic conductivity. With the improvement of electron and lithium-ion transport pathways, the kinetics of insertion and extraction processes are significantly enhanced, thus enabling faster charging and discharging rates. The structural enhancement of MXenes, combined with the conductive advantages of Au NPs, leads to improved cycling stability, which significantly reduces capacity decay in long-term use. The designed and constructed V₂O₅—Ti₂C₃ heterostructures are interconnected by interfacial TiO₂ layers, which promote the formation of oxygen vacancies and the generation of local stresses, and the intercalation of lithium ions is enhanced through synergistic redox and electronic interactions. The titanium atoms are further anchored with Au NPs to form gold-titanium bonds (AuTi₃, Au₂Ti), further improving the interfacial conductivity and structural integrity. The interfacial TiO₂ layer formed between V₂O₅ and Ti₂C₃ can anchor the oxide, reduce lattice mismatch, introduce oxygen vacancies, and promote electron/ion transport, thereby improving the electrochemical performance. The 3DP-VTA composite material provides ideas for higher performance energy storage systems.

The lamellar architecture constructed by the 3DP-DIW technology forms an interconnected ion transport channel and an electronic conductive network to enhance ion transport and overall energy density. the precise control of the electrode thickness, porosity, and geometry is achieved through additive manufacturing technology, which satisfies the customized requirements for battery volume and performance of different microdevices and supports rapid iterative optimization; as well as the optimized material usage to reduce waste. The electrode thickness can be controlled, and when combined with the 3D-printed multi-layer stacked battery structure, it can meet the requirements of wearable devices, such as smart watches and implantable sensors, for “compact size and long battery endurance”. Structural stability ensures that the battery maintains stable performance under complex working conditions such as bending and vibration, and is suitable for outdoor operation of Internet of Things terminal devices, such as wireless sensor nodes.

The 2D conductive layer of MXenes and the catalytic sites of Au NPs are synergistically integrated into the V₂O₅ matrix to form a “conductive-catalytic-structural support” multifunctional composite system, which solves the problem that a single carbon-based material (such as graphene) only physically enhances conductivity and cannot suppress structural phase transition. Direct ink writing 3D printing technology enables the precise integration of nanoscale material dispersion with macroscopic structural control. Compared with conventional coating methods, this approach effectively prevents the agglomeration of active materials and ensures a uniform distribution of conductive additives. Moreover, it eliminates the need for high-temperature sintering, thereby reducing energy consumption and enhancing suitability for large-scale production.

Finally, it should be noted that the above embodiments are merely used for describing the technical solutions of the present disclosure, rather than limiting the same. Although the present disclosure has been described in detail with reference to the preferred examples, those of ordinary skill in the art should understand that the technical solutions of the present disclosure may still be modified or equivalently replaced. However, these modifications or substitutions should not make the modified technical solutions deviate from the spirit and scope of the technical solutions of the present disclosure.

What is claimed is:

1. A 3DP-nano-micro battery composite electrode material, wherein the composite electrode material comprises V₂O₅, Ti₃C₂ MXene material and Au NPs, wherein:
the V₂O₅ serves as a matrix material, functioning as an active substance that provides lithium-ion storage sites;
the Ti₃C₂MXene acts as a conductivity enhancer and structural support, is uniformly dispersed in the V₂O₅ matrix material in a 2D lamellar structure, and V₂O₅ and Ti₃C₂ MXene are connected by a defect-rich TiO₂ interlayer, wherein the TiO₂ interlayer is used to anchor oxides, reduce lattice mismatch and introduce oxygen vacancies;
wherein Au NPs, serving as catalytically active sites and ion transport accelerators, are anchored on Ti sites on the surface of Ti₃C₂ MXene to form conductive interfacial bonds, and are uniformly loaded on the surface of V₂O₅ and MXene lamellar gaps;
wherein the composite electrode material is 3D printed via a DIW technology to form a lamellar architecture that constructs an interconnected electronic conductive network and a lithium-ion transmission channel, with an accuracy control on a structure and a spatial distribution of the active material, thereby shortening an ion/electron transmission pathway.

2. The 3DP-nano-micro battery composite electrode material according to claim 1, wherein the formed lamellar architecture has a monolayer thickness ranging from 10 to 20 micrometers, and a total stack configuration of 2 to 8 layers, wherein individual lamellae are connected to the MXene layers through a TiO₂ interlayer, establishing heterojunction interfaces, so that a hierarchical heterostructure is generated throughout the composite electrode material.

3. The 3DP-nano-micro battery composite electrode material according to claim 1, wherein a pore structure of the composite electrode material can be adjusted by adjusting a solid phase content of the printed ink and printing parameters.

4. A nano-micro battery prepared by the 3DP-nano-micro battery composite electrode material according to claim 1, wherein a nano-micro battery structure comprises:
an anode, wherein the anode comprises a lithium cobalt oxide material prepared via 3D printing and arranged on a substrate, wherein a positive electrode shell is affixed a top of the substrate;
a cathode, wherein the cathode is composed of 3D-printed composite material, arranged on the substrate, and a negative electrode shell is disposed at a bottom of the substrate;
a separator, wherein the separator is a porous polyolefin membrane or a ceramic-coated separator, and is arranged between the anode and the cathode; and
an electrolyte, wherein the electrolyte is an organic electrolyte containing lithium ions, wherein during a charging process, the lithium ions are transferred from the anode to the cathode and inserted into an interlayer structure of the cathode material; wherein during a discharging process, the lithium ions are extracted from the cathode and migrate back to the anode.

5. An application for a nano-micro battery according to claim 4, wherein the nano-micro battery is applied to a wearable device, a medical implantable device, or an Internet of Things sensor.

6. A method for preparing a 3DP-nano-micro battery composite electrode material according to claim 1, wherein the method comprises the following steps:
S1, preparation of precursor ink by mixing V₂O₅ nanoparticles, Ti₃C₂ MXene material and Au NPs according to a mass ratio of 5:1-3:0.1-1, adding a binder containing a TiO₂ precursor and a solvent, and ultrasonically dispersing for 1-3 h to form a uniform ink, wherein the TiO₂ precursor is converted into the defect-rich TiO₂ interlayer in a subsequent treatment;
S2, 3D printing molding, comprising, utilizing a DIW technology, depositing the precursor ink layer-by--layer onto an aluminum substrate through a precision nozzle, with a single-layer printing thickness of 10-20 μm and an interlayer drying interval of 5-15 min, and repeating the sequence for a cumulative total of 2 to 8 layers to form a wet electrode blank; and
S3, post-treatment, comprising, firstly, vacuum drying the wet electrode blank at 60-80° C. for 12-24 h, subsequently performing a heat treatment at 300-400° C. for 1-2 h in an argon atmosphere, and removing the binder and strengthening interface bonding to yield the 3DP composite material, wherein in the heat treatment, the TiO₂ precursor is converted into a oxygen-deficient TiO₂ interlayer while conductive interfacial bonds are formed between the Au NPs with the Ti sites on the MXene surface.
